(19) United States
(12) Patent Application Publication
(10) Pub. No.: US 2020/0146392 A1
(43) Pub. Date: May 14, 2020

(54) FOOTWEAR AND RUBBER SOLE CONTAINING CORNCOB GRANULES

(71) Applicant: The Goodyear Tire & Rubber Company, Akron, OH (US)

(72) Inventor: Paul Harry Sandstrom, Cuyahoga Falls, OH (US)

(21) Appl. No.: 16/519,974

(22) Filed: Jul. 23, 2019

Related U.S. Application Data
(60) Provisional application No. 62/758,724, filed on Nov. 12, 2018.

(51) Int. Cl. A43B 13/02; A43B 13/04; A43B 13/22; C08L 9/06; C08L 7/00

(52) U.S. Cl. CPC A43B 13/026; A43B 13/04; A43B 13/22; C08L 2207/322; C08L 7/00; C08L 2205/03; C08L 2205/06; C08L 9/06

(57) ABSTRACT

The invention relates to footwear with a rubber sole where such sole is comprised of a rubber composition which contains corn cob granules.

### FIELD OF THE INVENTION

The invention relates to footwear with a rubber sole where such sole is comprised of a rubber composition which contains corn cob granules.

### BACKGROUND OF THE INVENTION

It is sometimes desirable for footwear to have a sole comprised of a rubber composition intended to promote traction upon ground engagement. Such traction may sometimes be referred to as grip.

For such purpose it is proposed to evaluate providing the rubber sole with a rubber composition containing corncob granules.

In practice, a conventional article of footwear includes a combination of two primary elements, namely an upper portion and a sole portion where the sole portion is intended to permit ground engagement. The upper portion of the footwear provides a covering for the foot of the wearer of the footwear and positions the foot with respect to the sole portion. The sole portion is secured to a lower part of the upper portion of the footwear and, in practice, is intended to be positioned between the upper portion and the ground upon ground engagement. The sole portion provides traction through its sole's outer surface upon ground engagement and aids in controlling foot balance and control for the footwear. Accordingly, the upper portion and secured sole portion operate in a cooperative combination to provide a footwear structure suitable for one or more ambulatory activities such as, for example, walking, running and sports related activities.

For this invention, it is desired to evaluate providing a footwear rubber sole which contains a dispersion of corncob granules throughout the sole rubber composition and which contains micro-protrusions of the corncob granules on its the surface intended for ground contacting. In one embodiment, the exposed surface of the footwear's sole, intended to permit ground engagement, contains micro-cavities therein created by the wearing process of the footwear sole surface (such as, for example, during ambulatory activities) to cause a release of a portion of the micro-protrusions of the corncob granules from the footwear sole surface.

It is considered that such practice is novel and a departure from past practice for footwear rubber soles and footwear containing rubber soles.

In the description of this invention, the terms “rubber” and “elastomer” where used herein, unless otherwise prescribed, are used interchangeably. The terms rubber “composition” or “compound” where used herein, unless otherwise prescribed, generally refers to a composition in which one or several rubbers are blended or mixed with various ingredients or materials. A term “compounding ingredient” where used herein unless otherwise prescribed, generally refers to ingredients used to prepare rubber compositions, or compounds. Such terms are well known to those having skill in the rubber mixing and compounding art. The term “corncob granules” is used herein to refer to corncob granules which are obtained from the woody ring surrounding the central core, or pith, of the corncob.

The corncob granules are conventionally manufactured by drying the woody ring portion, or fraction, of the corncob followed by grinding to produce the granules which are air cleaned and separated into various sizes by mesh screening. Such corncob granules may be provided, for example, by The Andersons, Inc., and sold as Grit-O Cobs®. For further corncob granule discussion, see Use of Fine-R-Cobs as a Filler for Plastics, by D. B. Vanderhooven and J. G. Moore, reprinted from the Internal Wire and Cable Symposium 1982.

The term “phr”, where used herein and according to conventional practice, refers to parts by weight of respective material per 100 parts by weight of rubber. The Tg of a rubber or rubber compound, where used herein unless otherwise prescribed, refers to its glass transition temperature which can be conventionally determined, for example, by differential scanning calorimeter at a heating rate of 10° C. per minute. It is understood that such Tg determination is well known to those having skill in such art.

### SUMMARY AND PRACTICE OF THE INVENTION

In accordance with this invention, a footwear rubber sole is comprised of a rubber composition comprised of, based upon parts by weight per 100 parts by weight of rubber (phr):

(A) at least one elastomer, desirably at least one conjugated diene-based elastomer;

(B) about 0.1 to about 30, alternatively about 1 to about 20, phr of corncob granules comprised of granules of the woody ring of corncobs, wherein at least 90 percent of said corncob granules have an average diameter in a range of from about 20 to about 500, alternately from about 30 to about 300, microns;

(C) about 20 to about 110, alternatively about 30 to about 100, phr of reinforcing filler comprised of:
(1) from zero to about 110, alternately about 30 to about 80, phr of precipitated silica (synthetic amorphous silica) aggregates containing hydroxyl groups (e.g. silanol groups) on the surface thereof, and
(2) from zero to about 110, alternately from about 5 to about 80 or about 30 to about 80, phr of rubber reinforcing carbon black.

In one embodiment, the precipitated silica-containing rubber composition also contains at least one silica coupling agent for the precipitated silica, (for example from about 0.5 to about 10 phr of silica coupling agent) having a moiety reactive with hydroxyl groups on said precipitated silica and another different moiety interactive with at least one of said conjugated diene-based elastomer(s),

In further accordance with this invention, a footwear rubber sole is provided having a surface comprised of said rubber composition which contains corncob micro-protrusions and micro-cavities thereon formed by a release of a portion of said corncob granule protrusions from the footwear sole surface (for example by release, or ejection, of the corncob granule protrusions from the footwear sole surface resulting from a wearing, or abrading, away of the sole surface as it is being used). The combination of corncob granule micro-protrusions and of corncob granule promoted micro-cavities, are seen herein to provide a relatively rough texture to the footwear sole surface to thereby promote mechanical traction of the footwear sole over a substrate (e.g., ground) surface.

It is considered herein that the solid footwear rubber sole containing corncob dispersion within the sole rubber composition, provides corncob micro-protrusions and micro-cavities on the footwear rubber sole surface intended for substrate engagement is readily differentiated from and exclusive of a footwear sole comprised of closed cellular rubber.

In a further embodiment, the footwear rubber sole contains colored corncob granules having a color contrasting with the rubber sole. For such colored corncob granules, which may have singular or a plurality of colors in contrast to the color of the sole rubber composition to enhance their visibility, particularly the visibility of the corncob micro-protrusions, on a contrastingly colored sole surface background. Such colorant for the corncob granules may be, for example, a suitable dye or stain.

In further accordance with this invention, said rubber composition for said footwear rubber sole rubber composition is provided as being sulfur cured.

In practice, various elastomers, including conjugated diene-based elastomers, may be used for the sole rubber composition intended for ground contacting.

Representative of such elastomers are polymers comprised of at least one of isoprene and 1,3-butadiene and copolymers of styrene and at least one of isoprene and 1,3-butadiene.

Representative examples of such elastomers are, for example, comprised of cis 1,4-polyisoprene rubber, cis 1,4-polybutadiene rubber, styrene/butadiene copolymer rubber which may be at least one of emulsion polymerization prepared ESBR (containing from about 2 to about 3 parts by weight per 100 parts by weight rosin acid) and solution polymerization prepared SSBR, styrene/isoprene/butadiene rubber and isoprene/butadiene rubber as well as block polymers comprised of styrene-isoprene-styrene and of styrene-butadiene-styrene polymer blocks.

In one embodiment, said styrene/butadiene rubber is comprised of at least one of:

(A) organic solution polymerization prepared styrene/butadiene rubber (SSBR), and

(B) Aqueous emulsion polymerization prepared styrene/butadiene rubber (ESBR) containing from about 2 to about 3 parts by weight residual rosin acid per 100 parts by weight ESBR.

Such footwear sole rubber composition may also, if appropriate, contain up to about 25 phr of primarily saturated elastomers such as, for example, elastomers comprised of EPDM (ethylene/propylene/non-conjugated diene terpolymer rubber), butyl rubber (copolymer of isobutylene and conjugated diene such as, for example, isoprene, in minor amounts of about 3 to 6 percent,), halobutyl rubber (halogenated butyl rubber such as, for example, chlorobutyl and brominated butyl rubber) and brominated copolymers of paramethylstyrene and isobutylene and their mixtures. Non-conjugated dienes for said EPDM rubber may be, for example, at least one of ethylidene norbornadiene, trans 1,4-hexadiene and dicyclopentadiene.

In an additional embodiment, it is desired to evaluate providing the footwear sole as additionally containing zinc rosinate as a product of zinc oxide and rosin acid formed in situ within the footwear sole rubber composition, particularly of zinc oxide and freely added rosin acid to the rubber composition. The term “freely added” relates to addition of the rosin acid to the rubber composition in addition to any residual rosin acid which may be contained in any of the elastomers of footwear sole rubber composition such as, for example residual rosin acid remaining and thereby contained in an elastomer as a result of its preparation by aqueous emulsion polymerization in which an emulsifier is present of styrene and 1,3-butadiene (ESBR).

The combination of the corncob granules and precipitated silica particles together with the chemical bonding of such materials (corncob granules and silica particles) to the diene-based elastomer(s) such as, for example, by the coupling agent in the footwear sole rubber composition to thereby form a combination of corncob granule micro-protrusions associated micro-cavity depressions in the footwear outer sole surface is a significant departure from past practice.

It is considered, for example, that a complex reinforcing network for the footwear sole is formed in situ within the elastomer host (the footwear sole rubber composition) by the interaction of a moiety of the coupling agent at least in part with the hydroxyl groups of the precipitated silica aggregates, and potentially with the corncob granules, while the other and different moiety of the coupling agent interacts with the carbon-to-carbon bonds of the diene-based elastomer host.

For example, and in one aspect of the practice of the invention, in the case of a coupling agent containing an alkoxysilane moiety and another moiety as a polysulfide and/or mercapto moiety, said alkoxysilane moiety is seen herein to react with said hydroxyl groups of said precipitated silica aggregates and possibly the corncob granules and the polysulfide and/or mercapto moiety of the coupling agent is seen herein to interact with carbon-to-carbon bonds of the diene-based elastomer(s) within the elastomer host.

It is considered herein that a polysulfide bridge or mercapto moiety contained in the coupling agent, reacts with the diene-based elastomer(s) during the processing and/or curing of the rubber composition at an elevated temperature, to thereby couple said precipitated silica aggregates and possibly the corncob granules to the elastomer(s) of the rubber composition of the footwear sole to thereby create a complex rubber reinforcement network within the footwear sole composition. Such coupling reaction for precipitated silica aggregates themselves is recognized by those having skill in such art to be important for reinforcement of rubber compositions.

In this invention, it is considered that the aforesaid additional potential coupling reaction of the said corn cob granules to the diene-based elastomer(s) in situ within the elastomer host is important to enhance the traction of the footwear sole by intending to provide a degree of anchoring (bonding) of the corncob granule micro-protrusions to the footwear sole surface intended for ground engagement.

In practice and in one aspect of the invention, it is believed that the said corncob granules work by increasing the footwear sole mechanical frictional surface of the footwear sole in contact with the ground (substrate surface) such as for example, by the friction of the footwear sole surface on the substrate to which it is engaged which will additionally cause the rubber composition at the footwear sole surface and the corncob granules to abrade away to both partially expose more corncob granule micro-protrusions from the corncob granule dispersion within the footwear sole rubber composition and to create additional micro-cavities in the footwear sole surface itself, all resulting in an increased effective mechanical frictional surface of the footwear sole compared to a smooth surfaced footwear sole without such corncob granule micro-protrusions or such micro-cavities. After running or walking the footwear over various surfaces, a visual observation of the footwear sole surface may reveal numerous corncob granule micro-protrusions and/or resulting micro-cavities in the footwear sole surface which are partially exposed. It is acknowledged that, as the corncob granules abrade against a substrate over which the footwear sole is engaged, a portion of the granules may become modified, fractured or otherwise broken. Additionally, when such corncob granules are removed by the mechanical friction of the footwear sole surface against a substrate, the footwear sole surface becomes significantly rougher, in a sense of the formation of microporous cavities, than that of a footwear sole surface without such corncob granules contained in the footwear sole composition, all of which is considered to aid in providing mechanical traction for the footwear sole through the outer, engaging surface of its sole.

In the practice of this invention, numerous coupling agents may be used in coupling the precipitated silica and diene-based elastomers as well as the precipitated silica and potentially the corncob granules, to diene-based elastomer(s) of the footwear sole rubber composition. For example, various alkoxy silane based coupling agents recited in the aforesaid enumerated patents might be used which contain a polysulfide bridge such as, for example, bis(trialkoxysilylalkyl) polysulfide having an average of from about 2 to about 4 connecting sulfur atoms in the sulfur bridge where alkyl groups of the alkoxy group of the alkoxy silane based silica coupling agent may be selected from, for example, methyl, ethyl and propyl radicals, where at least one of the alkoxy groups is an ethoxy group. A representative example is bis(3-triethoxysilylpropyl) polysulfide. Other coupling agents may be, for example, alkoxyorganomercaptosilanes and blocked alkoxyorganomercaptosilanes.

The rubber composition of said sole may contain from about 10 to about 120 phr of particulate reinforcing fillers comprised of:

(A) carbon black, or

(B) precipitated silica, or

(C) a combination of rubber reinforcing carbon black and precipitated silica.

The rubber composition of said footwear sole may also contain fillers comprised of at least one of clay, talc, and calcium carbonate.

The rubber composition may also contain a silica coupler for said precipitated silica comprised of, as indicated, at least one of bis(3-triethoxysilylpropyl) polysulfide having an average in a range of from about 2 to about 4 connecting sulfur atoms in its polysulfidic bridge and of alkoxyorganomercaptosilane.

In one embodiment, said precipitated silica may be provided as a composite (a product of pre-treated precipitated silica prior to addition to the rubber composition) reacted with at least one of bis(3-triethoxysilylpropyl) polysulfide having an average in a range of from about 2 to about 4 connecting sulfur atoms in its polysulfidic bridge and of alkoxyorganomercaptosilane.

The commonly employed siliceous pigments used in rubber compounding applications can be used as the silica in this invention, including fumed, pyrogenic and precipitated siliceous pigments (silica), although precipitate silicas are preferred. The siliceous pigments preferably employed in this invention are precipitated silicas such as, for example, those obtained by the acidification of a soluble silicate, e.g., sodium silicate, and silicas precipitated therefrom by application of a suitable base.

The siliceous pigment (precipitated silica) may, for example, have a BET surface area, as measured using nitrogen gas, in a range of about 80 to about 300, although more usually in a range of about 100 to about 200, although perhaps even up to about 360, square meters per gram (m²/g). The BET method of measuring surface area is described 25 in the Journal of the American Chemical Society, Volume 60, Page 304 (1930).

The silica may typically have a dibutylphthalate (DBP) adsorption value in a range of about 150 to about 350, and usually about 200 to about 300 cubic centimeters per 100 grams (cc/100 g). Various commercially available silicas may be considered for use in this invention such as, for example and without limitation, silicas commercially available from PPG Industries under the Hi-Sil trademark with designations 210, 243, etc, silicas available from Solvay such as, for example, Zeosil 1165MP and silicas available from Evonik with designations such as, for example, VN2, VN3, BV 3370GR and silicas from J. M Huber Company such as, for example, Hubersil 8745.

In further practice of the invention said corncob granule containing footwear sole rubber composition contains, for example from about 2 to about 40, alternately about 5 to about 25 parts by weight per 100 parts by weight elastomer, rubber processing oils comprised of:

(A) petroleum based rubber processing oil,

(B) triglyceride vegetable oil, or

(C) combinations of petroleum based rubber processing oil and triglyceride vegetable oil, for example, in a weight ratio thereof of from about 10/1 to about 1/10 of petroleum based to vegetable based oils.

Representative of such triglyceride vegetable oils are, for example, soybean oil, sunflower oil, palm oil and rapeseed oil.

As previously mentioned, the footwear sole rubber composition may also contain zinc rosinate as a product of zinc oxide and freely added rosin acid, in addition to any residual rosin acid which may be contained in any elastomer of the sole rubber composition.

Such rosin acid is composed of freely added rosin acid together with any rosin acid which may be contained in an elastomer used in the footwear sole rubber composition. For example, and as previously indicated, emulsion polymerization prepared butadiene/styrene elastomer (ESBR) may contain from about 2 to about 3 parts by weight rosin acid per 100 parts by weight of the elastomer derived from the emulsion polymerization based production of the elastomer. The term “freely added” relates to rosin acid added as a compounding ingredient to the rubber composition which is in addition to rosin acid which may be contained in an elastomer used in the footwear sole rubber composition. Cis 1,4-polyisoprene elastomer, cis 1,4-polybutadiene elastomer and organic solvent solution polymerization prepared styrene/butadiene elastomer (SSBR) are not likely to contain any appreciable amount, if any, of rosin acid.

The zinc rosinate is considered to be a soap, whereas the rosin acid from which it is derived is not considered to be a fatty acid compared to stearic, palmitic and oleic acids and therefore the zinc rosinate is considered to be significantly differentiated from such products of such fatty acids with zinc oxide. For example, the zinc rosinate is considered to be a relatively sticky soap in the presence of water compared to the aforesaid slippery zinc fatty acid soap, and therefore the zinc rosinate may serve to more effectively promote a combination of wet and dry traction (traction of the footwear sole surface on various substrates under wet and dry substrate surface conditions). Such traction may sometimes referred to as “grip”, particularly where the sole rubber surface becomes wet as may be experienced where the sole surface engages a wet surface.

It is therefore, as indicated, desired to provide zinc rosinate within the corncob granule-containing footwear sole rubber composition instead of, or by replacing at least a portion of, zinc salt of fatty acids such as, for example stearic, palmitic and oleic acids which might normally be provided in the preparation of the rubber composition such as by free addition of such fatty acid and/or by such fatty acid contained in an elastomer (e.g. ESBR if used) of the rubber composition. Zinc rosinate, also as indicated, would be provided as a product of zinc oxide and rosin acid formed in situ within the rubber composition of the footwear sole, where a portion of the zinc rosinate product inherently migrates (blooms) to the outer surface of the footwear rubber sole (and thereby is contained on the surface of the footwear sole intended for substrate surface engagement) to thereby promote wet traction of the sole surface intended for ground engagement (e.g. promote traction of the footwear sole surface in contact with the ground surface, particularly a wet ground surface).

Therefore, said corncob granule-containing footwear sole rubber composition may additionally contain, for example, about 1 to about 10, alternately about 3 to about 10, phr of zinc soap comprised of:

(A) zinc rosinate as the product of zinc oxide and freely added rosin acid formed in situ within the rubber composition, or

(B) a combination of zinc soaps comprised of:
(1) about 25 to about 95, alternately about 50 to about 95 weight percent of said zinc rosinate, and
(2) about 5 to about 75, alternately about 5 to about 50 weight percent of zinc salt as the product of zinc oxide and fatty acid formed in situ within the rubber composition, where said fatty acid contains, and desirably is comprised primarily of a combination of, at least one of stearic, palmitic and oleic acids.

It is readily understood by those having skill in the art that the rubber composition of the footwear rubber sole would be compounded by methods generally known in the rubber compounding art, such as mixing the various sulfur-vulcanizable constituent diene polymers with various commonly used additive materials such as, for example, and where appropriate, curing aids, such as sulfur, activators, retarders and accelerators, processing additives, waxes, antioxidants and antiozonants, peptizing agents and aforementioned reinforcing fillers such as, for example, silica and rubber reinforcing carbon black. As known to those skilled in the art, depending on the intended use of the sulfur vulcanizable and sulfur vulcanized compositions the additives mentioned above, if used, are selected and commonly used in conventional amounts.

Various rubber reinforcing blacks might be used as may be appropriate. For example, although such examples are not intended to be limitive, are of the ASTM designation type N-299, N-234, N-220, N-134, N-115, and N-110. The selection of the type of carbon black, if used, is well within an optimization skill by one having skill in the rubber compounding art, depending somewhat upon the intended use, purpose and properties for the rubber composition. Typical amounts of tackifier resins, if used, may comprise about 0.5 to about 10 phr, more usually about 1 to about 5 phr. Typical amounts of processing aids may comprise for example, and if used, in a range of from about 1 to about 80 phr. Such processing aids may include, for example and where appropriate, aromatic, naphthenic, and/or paraffinic processing oils or plasticizer or medium molecular weight polyesters. Typical amounts of antioxidants may comprise, for example, about 1 to about 5 phr. Representative antioxidants may be selected from, for example and where appropriate, from those disclosed in The Vanderbilt Rubber Handbook (1978), Pages 344 through 346. Typical amounts of antiozonants may comprise, for example and where appropriate, about 1 to 5 phr. Typical amounts of waxes, where used and where appropriate, may comprise about 1 to about 5 phr. Typical amounts of peptizers, if used and where appropriate may comprise about 0.1 to about 1 phr.

Vulcanization conducted in the presence of a sulfur vulcanizing agent may be in the presence of elemental sulfur (free sulfur) and/or sulfur donating vulcanizing agents, if appropriate, such as for example, an amine disulfide, polymeric polysulfide or sulfur olefin adducts. Preferably, the sulfur vulcanizing agent is elemental sulfur. Sulfur vulcanizing agents may be used, for example, in an amount ranging from about 0.5 to about 4 phr, with a range of from about one to about 2.5, often being more desirable where appropriate.

Accelerators are used to control the time and/or temperature required for vulcanization and to improve the properties of the vulcanizate. Retarders may also be used, were and if appropriate to aid in controlling the vulcanization.

In one embodiment, a single accelerator system may be used, i.e., primary accelerator. Conventionally, and where appropriate, a primary accelerator(s) is used, for example, in an amount ranging from about 0.5 to about 4, often about 0.8 to about 2.5, phr. In another embodiment, combinations of a primary and/or a secondary accelerator might be used. Often a primary accelerator may be a sulfenamide. If a second accelerator is used, the secondary accelerator may be, for example, a guanidine, dithiocarbamate or thiuram compound.

The selection and amounts of most of the various compounding ingredients are not considered to be critical for the purposes of this invention, except where they may be especially emphasized elsewhere in this description, and can be adjusted or modified by the practitioner as deemed suitable for the desired tire tread properties.

The footwear rubber sole can be built, shaped, molded and cured by various methods which will be readily apparent to those having skill in such art.

The rubber composition may be and is preferably prepared by thermomechanically working and mixing the diene-based rubber and other rubber compounding ingredients, exclusive of the rubber curatives, in at least one sequential mixing step with at least one mechanical mixer, usually an internal rubber mixer, (usually referred to as “non-productive” mix stages), to a temperature which may be in a range of, for example, about 150° C. to about 190° for a sufficient duration of time, which may be, for example, within about 4 to about 8 minutes, followed by a final mix stage (usually referred to as a “productive mix stage) in which the curatives, such as sulfur and 5 accelerators, are added and mixed therewith which may be, for example, about 1 to about 4 minutes to a temperature which may be, for example, within a range of about 90° C. to about 125° C. The terms “non-productive” and “productive” mix stages are well known to those having skill in the rubber mixing art.

It is to be appreciated that the rubber composition is conventionally cooled to a temperature below about 40° C. between the aforesaid mix stages.

Vulcanization of the rubber composition may be accomplished at conventional vulcanization temperatures which may range, for example, from about 100° C. to about 200° C. Usually desirably, the vulcanization may be conducted at temperatures ranging from 120° C. to 180° C. Any of the usual vulcanization processes may be used, as may be appropriate such as heating in a press or mold, heating with superheated steam or hot air or in a salt bath.

The invention may be further understood by reference to the following examples in which the parts and percentages are by weight unless otherwise indicated.

### EXAMPLE I

This Example, derived from Example I of U.S. Pat. No. 7,249,621, relates to providing corncob granules in a rubber composition for a tire tread which is presented here for said evaluation of providing corncob granules in a footwear rubber sole rubber composition.

Samples of diene hydrocarbon based rubber compositions were prepared and are identified herein as Samples 1 through 5, with Sample 1 being a control sample.

Control Sample 1 contains cis 1,4-polyisoprene natural rubber having a Tg (glass transition temperature) of about −65° C. and an emulsion polymerization prepared styrene/butadiene copolymer elastomer (E-SBR) having a Tg of about −55° C.

Samples 2 through 5 are similar to the control Sample 1 except that they contain various amounts of corncob granules.

The compositions were prepared by mixing the ingredients in several stages, namely, two sequential non-productive mixing steps (without the curatives, namely the sulfur and accelerators) followed by a productive mix stage (in which the curatives are added), and the resulting composition was cured under conditions of elevated pressure and temperature.

For the non-productive mixing stages, the ingredients are mixed in an internal rubber mixer for about 4 minutes each to a temperature of about 160° C. following which the rubber composition is removed from the mixer, roll milled, sheeted out and allowed to cool to a temperature below 40° C. after each non-productive mixing stage.

In a subsequent productive mixing stage, the curatives are mixed with the rubber composition in an internal rubber mixer for about 2 minutes to a temperature of about 110° C. following which the rubber composition is removed from the mixer, roll milled, sheeted out and allowed to cool to a temperature below 40° C.

The rubber compositions are illustrated in the following Table 1 derived from the aforesaid U.S. patent.

TABLE 1

| | Samples | | | | |
|---|---|---|---|---|---|
| | Control | | | | |
| | 1 | 2 | 3 | 4 | 5 |
| First Non-Productive | | | | | |
| Mixing Step | | | | | |
| E-SBR¹ | 85 | 85 | 85 | 85 | 85 |
| Natural rubber² | 15 | 15 | 15 | 15 | 15 |
| Carbon black³ | 49 | 49 | 49 | 49 | 45 |
| Processing aids⁴ | 18 | 18 | 18 | 18 | 18 |
| Antidegradant⁵ | 3.5 | 3.5 | 3.5 | 3.5 | 3.5 |
| Zinc oxide | 0.9 | 0.9 | 0.9 | 0.9 | 0.9 |
| Corncob granules⁶ | 0 | 2.5 | 5 | 10 | 10 |
| Second Non-Productive | | | | | |
| Mixing Step | | | | | |
| Carbon black³ | 16 | 16 | 16 | 16 | 16 |
| Processing aids⁴ | 12.5 | 12.5 | 12.5 | 12.5 | 12.5 |
| Productive Mixing Step | | | | | |
| Zinc oxide | 2.1 | 2.1 | 2.1 | 2.1 | 2.1 |
| Antidegradant⁵ | 1.2 | 1.2 | 1.2 | 1.2 | 1.2 |
| Accelerator(s)⁷ | 2.7 | 2.7 | 2.7 | 2.7 | 2.7 |
| Sulfur | 1.6 | 1.6 | 1.6 | 1.6 | 1.6 |
| Retarder | 0.5 | 0.5 | 0.5 | 0.5 | 0.5 |

¹Styrene/butadiene copolymer elastomer as PLF1502 ™ from The Goodyear Tire & Rubber Company containing about 23.5 percent bound styrene and having a Tg of about −55° C.
²Cis 1,4-polyisoprene natural rubber (TSR20)
³N550 rubber reinforcing carbon black, ASTM designation
⁴Rubber processing oil and microcrystalline wax as processing aids and fatty acid as primarily stearic acid
⁵Of the quinoline and amine types
⁶Corncob granules as 60 Grit-O' cobs ® from The Andersons, Inc.
⁷Benzothiazyl disulfide and tetramethyl thiuram disulfide

The following Table 2 derived from the aforesaid U.S. patent reports physical data for various physical properties of the samples. For cured rubber samples, the respective samples were cured for about 60 minutes to a temperature of about 160° C.

TABLE 2

| | Samples | | | | |
|---|---|---|---|---|---|
| | Control | | | | |
| | 1 | 2 | 3 | 4 | 5 |
| Carbon black | 65 | 65 | 65 | 65 | 61 |
| Corncob granules | 0 | 2.5 | 5 | 10 | 10 |
| Rheometer, 170° C. (MDR)¹ | | | | | |
| Maximum torque (dNm) | 13.3 | 13.6 | 13.6 | 13.5 | 13 |
| Minimum torque (dNm) | 1.9 | 2 | 1.7 | 2 | 1.9 |
| Delta torque (dNm) | 11.4 | 11.6 | 11.9 | 11.5 | 11.1 |
| T90, minutes | 7.5 | 7.7 | 7.8 | 8.1 | 8.1 |
| Stress-strain (ATS)² | | | | | |
| Tensile strength (MPa) | 17.6 | 15.5 | 15 | 13.2 | 13.3 |
| Elongation at break (%) | 577 | 531 | 533 | 526 | 540 |
| 300% modulus, ring (MPa) | 8.1 | 8 | 7.9 | 7.2 | 6.7 |
| Rebound (%) | | | | | |
| 23° C. | 30 | 29 | 30 | 30 | 31 |
| 100° C. | 42 | 41 | 42 | 42 | 42 |
| Hardness (Shore A)³ | | | | | |
| 23° C. | 71 | 71 | 73 | 73 | 73 |
| 100° C. | 57 | 58 | 59 | 59 | 58 |
| Tear strength, 95° C. (N)⁴ | 193 | 165 | 138 | 113 | 65 |
| Pierced groove flex (mm | 0.54 | 0.55 | 0.64 | 0.62 | 0.69 |
| @120 minutes)⁵ | | | | | |
| DIN abrasion (2.5N) | 132 | 145 | 156 | 183 | 190 |
| relative cc loss⁶ | | | | | |
| RPA, 100° C.⁷ | | | | | |
| G′ at 10% strain (kPa) | 970 | 1004 | 1004 | 964 | 905 |
| Tan delta at 10% strain | 0.254 | 0.259 | 0.259 | 0.261 | 0.246 |
| Sample surface visual | 1 | 2 | 3 | 5 | 5 |
| observation ratings⁸ | | | | | |

¹Data obtained according to moving die rheometer instrument, model MDR-2000 by Alpha Technologies, used for determining cure characteristics of elastomeric materials, such as for example torque, T90 etc.
²Data obtained according to automated testing system instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³Shore A hardness according to ASTM D-1415
⁴Data obtained according to a peel strength adhesion (tear strength) test to determine interfacial adhesion between two samples of a rubber composition. In particular, such interfacial adhesion is determined by pulling one rubber composition away from the other at a right angle to the untorn test specimen with the two ends of the rubber compositions being pulled apart at a 180° angle to each other using an Instron instrument.
⁵Pierced groove flex values were determined by continuous dynamic flexing and measuring the extent of crack growth and expressed in terms of millimeters (mm) at 240 minutes of flexing at 23° C.
⁶DIN abrasion (relative to a control) according to DIN 53516
⁷Data obtained according to rubber process analyzer as RPA 2000 ™ instrument by Alpha Technologies, formerly the Flexsys Company and formerly the Monsanto Company. References to an RPA-2000 instrument may be found in the following publications: H. A. Palowski, et al, Rubber World, June 1992 and January 1997, as well as Rubber & Plastics News, Apr. 26, 1993 and May 10, 1993.
⁸Sample surface roughness using a graduated visual observation rating of from 1 to 5 with a rating of 1 for a smooth rubber surface and a rating of 5 for a relatively very rough rubber surface (caused by the corncob granules of which the majority are covered by a relatively thin rubber membrane).

From Table 2 it is observed that the rebound and hardness properties remained fairly constant with the addition of 2.5 to 10 phr of the corncob granules. However, tensile strength, tear strength and DIN abrasion properties became somewhat worse than those for the control sample, particularly at the 10 phr level of corncob granule addition.

From Table 2 it is also observed that the cured samples exhibited very small overall micro protrusions of the corncob granules, with the majority being covered by thin rubber membrane at the surface and also that abraded and torn portions of the respective samples exhibited numerous micro-cavities resulting from the displacement of individual protruded corncob granules. The resulting increase of the surface area and edges due to the presence of both the micro protrusions and micro-cavities are considered herein to provide increased traction particularly for winter driving conditions for a tire having a tread of the rubber composition.

Accordingly, it is concluded herein that a footwear rubber sole of a rubber composition containing corncob granules can aid in promoting traction the footwear sole's surface upon engagement of a substrate (e.g. ground) surface.

### EXAMPLE II

This Example, derived from Example II of U.S. Pat. No. 7,249,621, relates to providing corncob granules in a rubber composition for a tire tread which is presented here for said evaluation of providing corncob granules in a footwear rubber sole rubber composition.

Samples of diene hydrocarbon based rubber compositions were prepared and are identified herein as Samples 6 through 9, with Sample 6 being a control sample.

Control Sample 6 contains cis 1,4-polyisoprene natural rubber having a Tg of about −65° C. and a cis 1,4-polybutadiene rubber having a Tg of about −103° C.

Samples 7 through 9 are similar to control Sample 6 except that they contain various amounts of corncob granules.

The compositions were prepared in the manner of Example I.

The rubber compositions are illustrated in the following Table 3 derived from the aforesaid U.S. patent.

TABLE 3

| | Samples | | | |
|---|---|---|---|---|
| | Control | | | |
| | 6 | 7 | 8 | 9 |
| Non-Productive Mixing Step | | | | |
| Natural rubber¹ | 55 | 55 | 55 | 55 |
| Cis 1,4-polybutadiene rubber² | 45 | 45 | 45 | 45 |
| Carbon black³ | 48 | 48 | 48 | 48 |
| Processing aids⁴ | 14.8 | 14.8 | 14.8 | 14.8 |
| Antidegradant⁵ | 5.3 | 5.3 | 5.3 | 5.3 |
| Zinc oxide | 2 | 2 | 2 | 2 |
| Corncob granules⁶ | 0 | 2.5 | 5 | 10 |
| Productive Mixing Step | | | | |
| Zinc oxide | 3 | 3 | 3 | 3 |
| Antidegradant⁵ | 1 | 1 | 1 | 1 |
| Accelerators⁷ | 2.6 | 2.6 | 2.6 | 2.6 |
| Sulfur | 0.7 | 0.7 | 0.7 | 0.7 |

¹Cis 1,4-polyisoprene natural rubber (TSR20)
²Cis 1,4-polybutadiene rubber as BUD1207 ™ from The Goodyear Tire & Rubber Company having a Tg of about −103° C.
³N550 rubber reinforcing carbon black, ASTM designation
⁴Rubber processing oil and microcrystalline wax as processing aids and fatty acid as primarily stearic acid
⁵Of the quinoline and amine types
⁶Corncob granules as 60 Grit-O' Cobs ® from The Andersons, Inc.
⁷Benzothiazyl disulfide and tetramethyl thiuram disulfide

The following Table 4 reports physical data for various physical properties of the samples. For cured rubber samples, the respective samples were cured for about 60 minutes to a temperature of about 160° C.

TABLE 4

| | Samples | | | |
|---|---|---|---|---|
| | Control | | | |
| | 6 | 7 | 8 | 9 |
| Corncob granules | 0 | 2.5 | 5 | 10 |
| Rheometer, 160° C. (MDR)¹ | | | | |
| Maximum torque (dNm) | 16.2 | 16.7 | 16.8 | 17.4 |
| Minimum torque (dNm) | 2.1 | 2.3 | 2.3 | 2.6 |
| Delta torque (dNm) | 14.1 | 14.4 | 14.5 | 14.8 |
| T90, minutes | 12.3 | 11.7 | 11.7 | 11 |
| Stress-strain (ATS)² | | | | |
| Tensile strength (MPa) | 17.5 | 15.6 | 14.6 | 12.9 |
| Elongation at break (%) | 528 | 499 | 488 | 473 |
| 300% modulus, ring (MPa) | 7.5 | 7.5 | 7.3 | 7 |
| Rebound (%) | | | | |
| 23° C. | 49 | 48 | 49 | 48 |
| 100° C. | 59 | 58 | 58 | 57 |
| Hardness (Shore A)³ | | | | |
| 23° C. | 60 | 61 | 62 | 63 |
| 100° C. | 57 | 58 | 58 | 60 |
| Tear strength, 95° C. (N)⁴ | 92 | 95 | 94 | 102 |
| Pierced groove flex (mm at | 0.59 | 0.74 | 0.55 | 0.6 |
| 240 minutes)⁵ | | | | |
| Sample surface visual observation⁸ | 1 | 2 | 3 | 5 |
| Static ozone test | | | | |
| 50 pphm at 23° C., 25% strain | No visual surface cracks | | | |
| Dynamic ozone test | | | | |

| | |
|---|---|
| 50 pphm, 13° C., 25% strain | Edge cracks only |

From Table 4 it is observed that the addition of the corncob granules at a level of from 2.5 to 10 phr had a small effect on cured properties except for a reduction of tensile strength at the 10 phr level.

Accordingly, it is concluded herein that a footwear rubber sole of a rubber composition containing corncob granules can aid in promoting traction the footwear sole's surface upon engagement of a substrate (e.g. ground) surface.

### EXAMPLE III

### A Control

This Example, derived from an example presented in U.S. Pat. No. 9,163,126, relates to providing zinc rosinate in a rubber composition as a product of zinc oxide with rosin acid formed in situ within the rubber composition and thereby relates to the aforesaid evaluation of providing such zinc rosinate in a footwear rubber sole rubber composition. Tables 1 and 2 have been re-labeled herein as Tables 5 and 6, and Samples G through L have been re-labeled 10 through 15, to present a chronological order of tables and samples.

For this Example, rosin acid was introduced in a rubber composition in combination with zinc oxide to enable an in situ formation of zinc rosinate within the rubber composition,

Silica-rich rubber compositions were prepared as rubber Samples 10 through 15. Rubber Sample 10 was a control rubber sample formulated with 3 phr of zinc oxide and 1 phr of fatty acids comprised of stearic, palmitic and oleic acids to form salts of such fatty acids in situ within the rubber composition. Rubber Samples 11 and 12 were formulated with 3 phr and 6 phr of the fatty acids, respectively, while maintaining 3 phr of zinc oxide. Rubber Samples 13, 14, and 15 were formulated with 3 phr zinc oxide and rosin acid (instead of the aforesaid fatty acids) in amounts of 1, 3 and 6 phr of rosin acid, respectively, to form zinc rosinate in situ within the rubber composition.

The following Table 5 derived from the aforesaid US Patent illustrates a summary of the formulations.

TABLE 5

| | phr |
|---|---|
| Non-Productive Mixing Stage (4 min to | |
| 170° C. drop temperature) | |
| Solution styrene/butadiene rubber (SBR)¹ | 74 |
| Cis 1,4-polybutadiene rubber² | 26 |
| Precipitated silica³ | 73 |
| Carbon black | 10 |
| Processing oil, wax | 9 |
| Silane coupling agent⁴ | 6.5 |
| Antidegradant⁵ | 3 |
| Zinc oxide | 3 |
| Traction resin⁶ | 5 |
| Fatty acids (10-12) or rosin acid⁷ (13-15) | 1, 3 and 6 |
| Second Non-productive mixing stage | |
| (3 minutes to 160° C. drop temperature) | |
| No additional ingredients added | |
| Productive mixing stage (2 minutes to | |
| 120° C. drop temperature) | |
| Sulfur | 1.9 |
| Sulfenamide accelerator | 1.7 |
| Diphenyl guanidine accelerator | 1.5 |

¹SLF31X22 from The Goodyear Tire & Rubber Company
²Budene 1207 from The Goodyear Tire & Rubber Company
³Z1165MP ™ from Rhone-Poulenc
⁴NXT ™ from GE Silicones
⁵Amine type
⁶Coumarone-indene resin
⁷Gum rosin

The rubber composition samples were prepared by mixing the elastomers together with the identified rubber compounding ingredients in a first non-productive mixing stage (NP) in an internal rubber mixer for about 4 minutes at a temperature of about 170° C. The mixture was then further sequentially mixed in a second non-productive mixing stage (NP) in an internal rubber mixer, with no additional ingredients added, for about 3 more minutes at a temperature of about 160° C. The resulting mixture was then mixed in a productive mixing stage (P) in an internal rubber mixer with curatives for about 2 minutes at a temperature of about 120° C. The rubber composition was cooled to below 40° C. between the non-productive mixing steps and between the second non-productive mixing step and the productive mixing step.

The following Table 6 derived from the aforesaid U.S. patent illustrates the cure behavior and various physical properties of the silica-rich rubber compositions based on the basic recipe of Table 3 and reported herein as rubber Samples 10 through 15.

TABLE 6

| | Samples | | | | | |
|---|---|---|---|---|---|---|
| | Control | | | | | |
| | 10 | 11 | 12 | 13 | 14 | 15 |
| Fatty acids, (phr) | 1 | 3 | 6 | 0 | 0 | 0 |
| Rosin acid (phr) | 0 | 0 | 0 | 1 | 3 | 6 |
| Processing | | | | | | |
| Uncured (G′)¹ | 256 | 203 | 184 | 249 | 224 | 187 |
| Wet² | | | | | | |
| 0° C. rebound | 19 | 18 | 19 | 18 | 17 | 15 |
| 23° C. rebound | 36 | 38 | 34 | 34 | 31 | 28 |
| Handling³ | | | | | | |
| G′ @ 10% | 2261 | 1854 | 1598 | 2157 | 2100 | 1477 |
| Modulus at 300% | 10.4 | 9.1 | 8.3 | 10.6 | 9.1 | 7.4 |
| Hot hardness | 60 | 59 | 59 | 59 | 59 | 60 |
| RR⁴ | | | | | | |
| Rebound, 100° C. | 56 | 58 | 61 | 55 | 52 | 51 |
| TD (tan delta) at 100° C., RPA | 0.14 | 0.12 | 0.11 | 0.14 | 0.14 | 0.13 |
| Wear⁵ | | | | | | |
| DIN abrasion | 108 | 137 | 135 | 115 | 131 | 143 |
| COF⁶ | | | | | | |
| Dry | 1.54 | 1.53 | 1.57 | 1.62 | 1.56 | 1.64 |
| Wet | 0.32 | 0.34 | 0.33 | 0.35 | 0.43 | 0.52 |
| Tear | | | | | | |
| Original | 82 | 77 | 76 | 81 | 97 | 135 |

¹Uncured G′ was measured using ASTM D6601 on an RPA 2000
²Rebound was measured using ASTM D1054
³Modulus at 300 percent was measured using ASTM D1042
⁴Rebound at 100° C. was measured using ASTM D1415
⁵DIN abrasion was measured using ASTM 596.3
⁶Coefficient of friction (COF) measured using ASTM D1894. COF value for a rubber sample may be measured, for example, on a Model SP-200 Slip/Peel tester from IMASS, Inc. at six inches (about 15.2 cm) per minutes using a 200 g sled against a substrate surface such as, for example, a polished aluminum surface

From Table 6 it can be seen in Samples 10 through 12, the increase of fatty acid provides no appreciable change in either of the dry or wet coefficient of friction (COF) values.

However, the coefficient of friction values for Samples 13, 14 and 15 (which contained the zinc rosinate formed in situ within the rubber compositions as a product of rosin acid, instead of the fatty acid, and zinc oxide) were dramatically improved for wet substrate conditions as compared to Samples 10, 11 and 12 and also showed a small improvement for dry COF.

Accordingly, it is concluded herein that a footwear sole of a rubber composition containing corncob granules which also contains a zinc soap in the form of zinc rosinate as a product of zinc oxide and freely added rosin acid, which may be in addition to any residual rosin acid which might be contained in an elastomer in the rubber composition can promote a coefficient of friction of the footwear sole's surface intended for contacting or engaging a substrate surface.

While certain representative embodiments and details have been shown for the purpose of illustrating the invention, it will be apparent to those skilled in this art that various changes and modifications may be made therein without departing from the spirit or scope of the invention.

1. A footwear rubber sole intended for ground engagement comprised of a rubber composition which contains a dispersion of corncob granules and where the outer surface of said rubber sole intended for ground engagement contains micro-protrusions of the corncob granules, wherein said rubber composition contains, based on parts per 100 parts by weight rubber (phr):
(A) at least one conjugated diene-based rubber, and
(B) about 0.1 to about 30 phr of corncob granules.

2. The footwear rubber sole of claim 1 wherein its outer surface contains micro-cavities created by release of a portion of said micro-protrusions of said corncob granules.

3. The footwear rubber sole of claim 1 wherein said rubber composition contains reinforcing filler comprised of:
(A) rubber reinforcing carbon black, or
(B) precipitated silica together with silica coupler having a moiety reactive with hydroxyl groups on said precipitated silica and another different moiety interactive with said diene-based rubber, or
(C) a combination of said rubber reinforcing carbon back and precipitated silica together with said silica coupler.

4. The footwear rubber sole of claim 1 comprised of a rubber composition which contains from about 2 to about 40 phr of rubber processing oils comprised of:
(A) petroleum based rubber processing oil,
(B) triglyceride vegetable oil, or
(C) combination of a petroleum based rubber processing oil and triglyceride vegetable oil.

5. The footwear rubber sole of claim 4 wherein said triglyceride vegetable oil is comprised of at least one of soybean oil, sunflower oil, palm oil and rapeseed oil.

6. The footwear rubber sole of claim 1 wherein said rubber sole rubber composition is provided as being sulfur cured.

7. The footwear rubber sole of claim 1 wherein said conjugated diene-based elastomer is comprised of at least one of cis 1,4-polyisoprene rubber, cis 1,4-polybutadiene rubber, styrene/butadiene copolymer rubber, styrene/isoprene/butadiene terpolymer rubber, isoprene/butadiene rubber and block polymers comprised of styrene-isoprene-styrene and of styrene-butadiene-styrene polymer blocks.

8. The footwear rubber sole of claim 1 wherein said conjugated diene based elastomer is comprised of at least one of cis 1,4-polyisoprene rubber, cis 1,4-polybutadiene rubber and styrene/butadiene rubber, where said styrene/butadiene rubber is comprised of at least one of:
(A) organic solution polymerization prepared styrene/butadiene rubber (SSBR), and
(B) aqueous emulsion polymerization prepared styrene/butadiene rubber (ESBR) containing from about 2 to about 3 parts by weight residual rosin acid per 100 parts by weight ESBR.

9. The footwear rubber sole of claim 1 wherein said elastomer also includes up to about 25 phr of at least one of ethylene/propylene/non-conjugated diene terpolymer rubber, butyl rubber, halobutyl rubber and brominated copolymers of paramethylstyrene and isobutylene and their mixtures.

10. The footwear rubber sole of claim 9 wherein said elastomer is an ethylene/propylene/non-conjugated diene terpolymer where said non-conjugated diene is comprised of at least one of ethylidene norbornadiene, trans 1,4-hexadiene and dicyclopentadiene.

11. The footwear rubber sole of claim 1 wherein said rubber composition contains from about 10 to about 120 phr of particulate reinforcing fillers comprised of:
(A) carbon black, or
(B) precipitated silica, or
(C) a combination of rubber reinforcing carbon black and precipitated silica.

12. The footwear rubber sole of claim 1 which contains at least one of clay, talc, and calcium carbonate.

13. The footwear rubber sole of claim 11 which contains a silica coupler for said precipitated silica having a moiety reactive with hydroxyl groups contained on the precipitated silica and another moiety interactive with the conjugated diene-based elastomer(s).

14. The footwear rubber sole of claim 13 wherein said silica coupler is comprised of:
(A) a bis-(3-trialkloxysilylalkyl) polysulfide having an average of from 2 to about 4 connecting sulfur atoms in its polysulfidic bridge, or
(B) an organoalkoxymercaptosilane composition.

15. The footwear rubber sole of claim 14 wherein said silica coupler is a bis(3-trialkoxysilylalkyl) polysulfide comprised of bis(3-triethoxysilylpropyl) polysulfide.

16. The footwear rubber sole of claim 1 wherein said rubber composition also contains about 1 to about 10 phr of zinc soap comprised of zinc rosinate as a product formed in situ within the rubber composition of zinc oxide and freely added rosin acid.

17. The footwear rubber sole of claim 14 wherein said particulate reinforcing filler is comprised of precipitated silica,

18. The footwear rubber sole of claim 17 wherein said precipitated silica is provided as a product of precipitated silica and silica coupler comprised of bis(3-triethoxysilylpropyl) polysulfide having an average of from about 2 to about 4 connecting sulfur atoms in its polysulfidic bridge and of an alkoxyorganomercaptosilane.

19. The footwear rubber sole of claim 5 where said rubber composition of said rubber sole contains a combination of petroleum based rubber processing oil and vegetable oil.

20. An article of footwear containing the rubber sole of claim 1.
